(19) United States
(12) Patent Application Publication
(10) Pub. No.: US 2002/0023140 A1
(43) Pub. Date: Feb. 21, 2002

(54) Electronic document delivery system

(76) Inventors: John K. Hile, Monroe, MI (US); Michael R. Ward, Saline, MI (US); Robert E. Crosley, Monroe, MI (US); Joel F. Farley, Paso Robles, CA (US); John R. White, Saline, MI (US)

Correspondence Address: HARNESS, DICKEY & PIERCE, PLC, P.O. BOX 828, BLOOMFIELD HILLS, MI, 48303, US

(21) Appl. No.: 09/878,089

(22) Filed: Jun. 8, 2001

Related U.S. Application Data
(60) Provisional application No. 60/210,435, filed on Jun. 8, 2000.

(51) Int. Cl. G06F 15/16

(52) U.S. Cl. 709/217

(57) ABSTRACT

An improved method is provided for transferring data files between a first computing device and a second computing device interconnected by a network. The method includes: establishing a first network connection between the first computing device and a second computing device using the hypertext transfer protocol (HTTP); registering a file transfer request for a given data file with a server application residing on the second computing device; establishing a second network connection between the first computing device and the second computing device using HTTP; retrieving the file transfer request from the server application via the second network connection; and transferring the data file via the second network connection in response to the file transfer request retrieved from the server application.

This application claims priority under 35 U.S.C. §119(e) to U.S. Provisional Application No. 60/210,435 filed on Jun. 8, 2000.

### FIELD OF THE INVENTION

The present invention relates generally to an electronic document delivery system and, more particularly, to an improved method for transferring data files between a first computing device and a second computing device interconnected by a network.

### BACKGROUND OF THE INVENTION

While business and personal use of email is growing exponentially, email communication has some deficiencies. Email transmissions may be lost, intercepted or faked. In addition, email transmissions are generally not secure enough for delivery of confidential and/or business critical information. For instance, copies of email transmissions may remain on various mail servers interposed between the sender and recipient of an email message. Email transmissions may also have file size restrictions that further limits practicality.

Therefore, it is desirable to provide an easy-to-use web-based file transfer service that bypasses the vulnerabilities of email to securely and reliably deliver important messages, files or documents via an unsecured network such as the Internet. The file transfer service should employ a secure transfer mechanism for transmitting information between the sender and the recipient. It is envisioned that a web browser may be used to schedule a file transfer with a server application that coordinates file transfers and an independent client application may be used to execute the transfer of data files to a server. In this way, the client application can implement various secure delivery features as well as automatically transfer data files in accordance with predefined delivery schedules. This approach also allows for delivery of very large files and facilitates delivery recovery in the event an incomplete transfer without user intervention.

### SUMMARY OF THE INVENTION

In accordance with the present invention, an improved method is provided for transferring data files between a first computing device and a second computing device interconnected by a network. The method includes: establishing a first network connection between the first computing device and a second computing device; registering a file transfer request for a given data file with a server application residing on the second computing device; establishing a second network connection between the first computing device and the second computing device, such that the second network connection is independent from the first network connection; retrieving the file transfer request from the server application via the second network connection; and transferring the data file via the second network connection in response to the file transfer request retrieved from the server application.

For a more complete understanding of the invention, its objects and advantages, reference may be had to the following specification and to the accompanying drawings.

### BRIEF DESCRIPTION OF THE DRAWINGS

FIG. 1 is a diagram of a preferred embodiment of an electronic file delivery system in accordance with the present invention;

FIG. 2 is a diagram of an exemplary network configuration for the electronic file delivery system of the present invention;

FIG. 3 is a sequence diagram illustrating message flow for uploading a data file to a server in accordance with a preferred embodiment of the present invention;

FIG. 4 is a sequence diagram illustrating message flow for downloading a data file from a server in accordance with a preferred embodiment of the present invention;

FIG. 5 illustrates an exemplary Send web page in accordance with the present invention; and

FIG. 6 illustrates an exemplary Pick-up web page in accordance with the present invention.

### DETAILED DESCRIPTION OF THE PREFERRED EMBODIMENTS

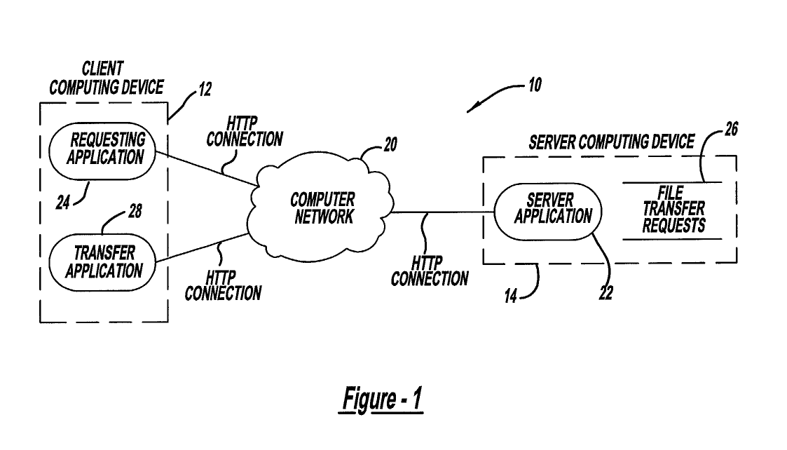

An electronic file delivery system 10 for transferring data files across a network is depicted in FIG. 1. The electronic file delivery system 10 includes a user subsystem residing on a first computing device 12 and a server subsystem residing on one or more server computers 14. The first computing device 12 and the second computing device 14 are interconnected by a computer network (e.g., the Internet) 20 as is well known in the art. While the following description is provided with reference to a computer network, it is readily understood that the broader aspects of the present invention are applicable to other types of network connections (e.g., wireless) which may interconnect two computing devices.

The server subsystem generally includes a server application 22 which is responsible for coordinating the execution of file transfer requests. A requesting application 24 associated with the user subsystem is operable to establish a network connection to the server application 22 and to register a file transfer request with the server application 22. A memory space 26 or other data storage means is accessible to the server application for storing each file transfer request. A transfer application 28 also associated with the user subsystem is operable to establish a second network connection to the server application 22 and to retrieve any applicable file transfer requests from the server application 22. The transfer application 28 is further operable to transfer data files to the server in response to the file transfer request retrieved from the server application 22. It is envisioned that the transfer may occur to the same server computer or to another file transfer server assigned by the server application 22 residing on the first server computer.

In a preferred embodiment, the electronic file delivery system 10 is implemented as a web-based system. In particular, the requesting application 24 may be implemented using any well known Web browser application, such as Netscape Navigator and Microsoft Internet Explorer, and the server application 22 may be implemented as a conventional Web server. In addition, the transfer application 28 may be implemented as a software agent as is well known in the art. The Web browser and the transfer agent establish network connections to the server application 22 using the hypertext transfer protocol (HTTP). While the following description is provided with reference to HTTP, it is readily understood that other network protocols residing at an application level and sitting atop TCP/IP are within the broader aspects of the present invention. For instance, Simple Mail Transfer Protocol (SMPT), Simple Object Access Protocol (SOAP), Lightweight Directory Access Protocol (LDAP), Internet Messaging Access Protocol (IMAP), and other similar protocols may be suitably used in the present invention.

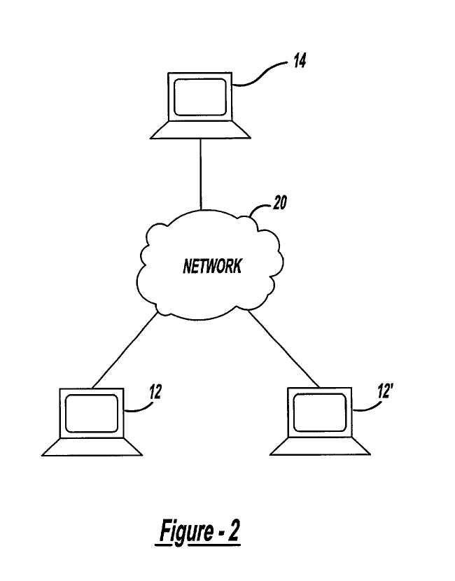

In a typical situation, a user desires to transfer one or more data files between two client computing devices 12 and 12′ which are interconnected by the network 20 as shown in FIG. 2. Each of the computing devices 12 and 12′ are configured with the above-described user subsystem. As will be more fully explained below, the server subsystem 14 serves as the intermediary for the file transfer between the two computing devices 12 and 12′.

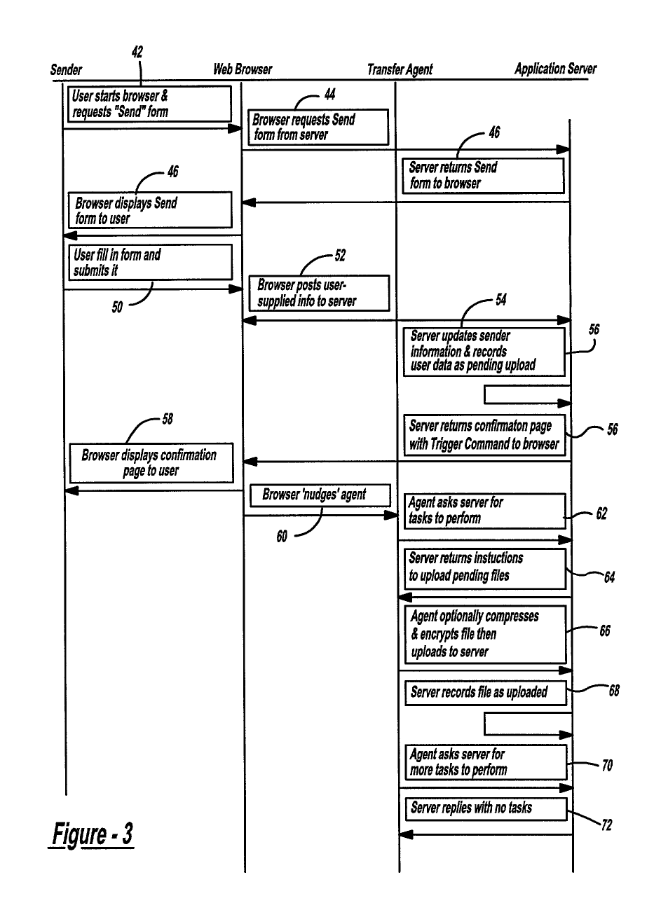

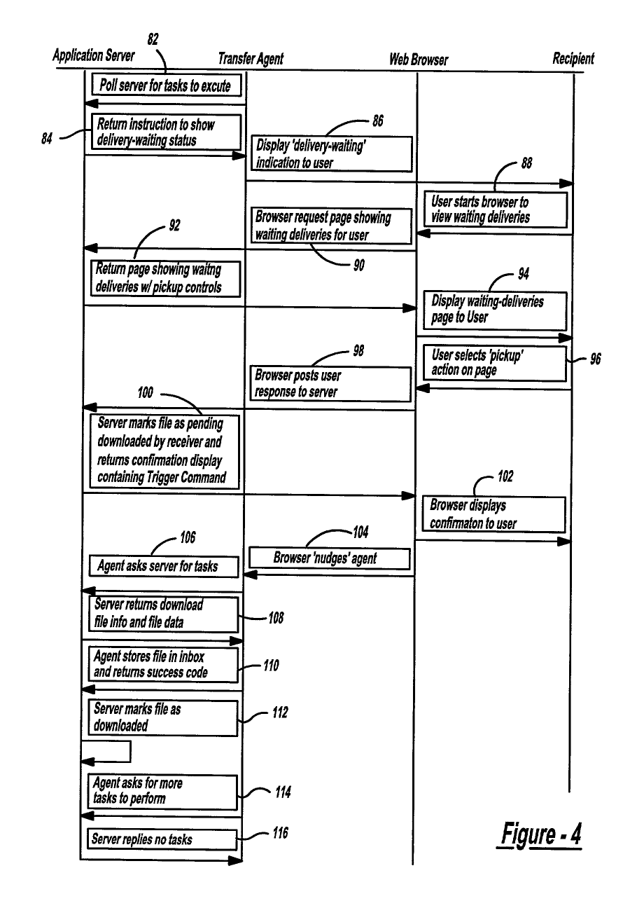

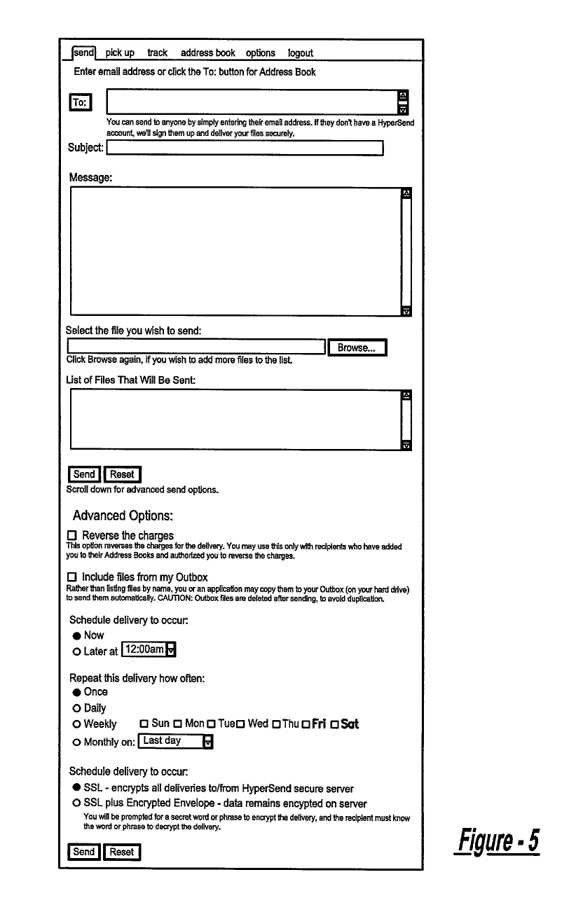

FIGS. 3 and 4 illustrate the message flow for transferring a data file from one user to another user in accordance with the present invention. Referring to FIG. 3, a first user initiates a file transfer by accessing their web browser. The user starts their web browser and requests a Send form from the web server as shown by the first two events 42 and 44. The web browser returns the Send form to the web browser in accordance with events 46 and 48. An exemplary Send form is illustrated in FIG. 5. Although a web browser is presently preferred for the requesting application, this is not intended as a limitation on the broader aspects of the present invention. It is envisioned that the requesting application may be a batch program that is periodically run to schedule regular occurring data file transfers. Moreover, it is further envisioned that the requesting application 24 and the transfer application 28 may reside on different computing devices. In this way, the transfer function may be off-loaded by the requesting application to another computing device.

To schedule or register a file transfer, the user fills in the Send form 50. In particular, the user enters an email address for the recipient of the file and selects the file or files they wish to send. The user may also enter a text message to accompany the file transfer as well as select various delivery options (e.g., delivery time, frequency of delivery retries, etc.). As will be more fully explained below, the separation of the requesting function and the execution function of the file transfer facilitates the implementation of various secure and automated delivery features. The user-supplied file transfer request information is then posted to the server in accordance with events 52 and 54.

Next, the selected file must be transferred from the sender's computing device to the server. The transfer agent is responsible for transferring applicable data files to the server. The transfer agent must poll the server application to determine which (if any) data files are to be uploaded to the server. This polling function may be initiated by any of three different techniques. First, the transfer agent may be executed during start-up of the sender's computing device. Second, the transfer agent may be executed at periodic time intervals (e.g., every half hour). The periodic time intervals may be controlled by the server in order to make scheduled and automatic delivers. Each time the transfer agent polls the server, the server includes in its reply the amount of time until the agent should poll again. Third, the transfer agent may be executed immediately following the registration of a file transfer request by a sender. This third technique is further illustrated in FIG. 3.

Once a file transfer request has been successfully posted to the server, the server application returns a Confirmation page to the web browser of the sender at event 56. The web browser in turn displays the Confirmation page at event 58. In addition, the Confirmation page includes a HTML scripting command or other type of trigger command that causes the web browser to initiate execution of the transfer agent as shown at event 60. It should be noted that the web browser does not pass any specific instructions or information to the transfer agent.

The transfer agent then polls the server application to retrieve file transfer request information from the server. To do so, the transfer agent establishes a second network connection to the server application that is independent of the network connection established by the web browser. The transfer agent asks the application server for any tasks that are to be performed at event 62. For each task, the server application downloads a set of file transfer instructions to the transfer agent in accordance with event 64. For instance, in order to upload a data file, the server application provides an identifier for the data file, along with corresponding delivery requirements, to the transfer agent.

To upload the requested data file, the transfer agent may employ various secure and automatable delivery features as shown at event 66. Such features are not generally available on file transfers performed directly by a browser. In a preferred embodiment, the transfer agent uses the industry-standard Secure Sockets Layer (SSL) protocol to transmit the data files. The SSL protocol uses a private key to encrypt data files that are transferred over the network connection. Many of the commercially available Web browsers support the SSL protocol. SSL protocol is the default delivery technique in the present invention. To the extent that the SSL protocol sits underneath HTTP, this configuration is referred to as HTTPS. However, it is envisioned that other secure protocols may also be used by the transfer agent.

For additional security, the user can chose to enclose data files in an Encrypted Envelope that only the recipient can open. The user is prompted for a secret word, phrase or other secret key at the time the file transfer request is scheduled. The data file is subsequently encrypted using the well known Blowfish encryption algorithm. It should be noted that the data file remains encrypted on the server. When the data file arrives at the recipient's computing device, the recipient must enter the secret word, phrase or other suitable secret key in order to open and decrypt the data file. While the above description has been provided with reference to particular examples, it is envisioned that the transfer agent may employ other user-authenticated, encryption and/or compression delivery techniques.

In any event, the requested data file is uploaded to and stored on the server. If a file transfer is interrupted prior to completion, it is envisioned that the transfer can automatically be resumed without further user action once the transfer agent is able to re-establish a network connection to the server. Once a data file is successfully uploaded to the server, the server application marks the file as uploaded at event 68. The transfer agent inquires the server for more tasks to be performed. When the server application replies that no more tasks remain, the polling process is complete as shown at event 72. In this way, one or more data files are transferred by the transfer agent to the server.

By segmenting the requesting function from the transfer function, the present invention is able to easily accommodate the implementation of various secure delivery features. Segmenting the requesting function from the transfer function further allows a user to schedule numerous and/or vary large file transfers quickly without waiting for the lengthy exchange of the file contents themselves. The transfer agent can automatically exchange the file content after the user has gone on to other tasks. Further, if the transfer is interrupted by a loss of the network connection or other computing problems, the transfer agent can automatically resume the file transfer without further manual intervention from the user.

Subsequently, uploaded data files may be downloaded to the applicable recipient as described in relation to FIG. 4. In order to download a data file, the recipient should be notified of the pending delivery. In accordance with the present invention, the recipient may be notified in one of two ways. First, the recipient may be automatically sent an out-of-band message as part of the uploading process by the server application when an upload is completed. For instance, an email message may be sent via an interface between the server and a conventional email application. The email message is then viewed by the recipient using a conventional email application residing on the recipient's computing device. Other suitable notification mechanisms might include a pager message or an automated voice announcement via the telephone.

Alternatively, a delivery-waiting message may be displayed by the transfer agent residing on the recipient's computing device as shown in FIG. 4. As previously noted, the recipient's computing device is configured with a web browser and a transfer agent. The transfer agent may periodically poll the server for tasks to be performed in accordance with event 82. If a data file is awaiting delivery, the server application returns an instruction to display a delivery-waiting message to the recipient at event 84. The transfer agent in turn displays a delivery-waiting indicator to the recipient at event 86. The transfer agent can also be configured to download files automatically without user intervention.

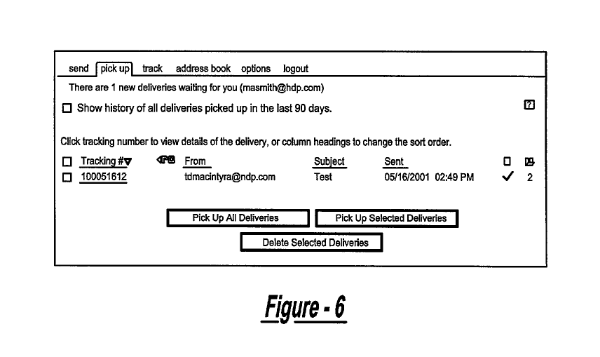

This prompts the recipient to start their web browser in order to view the pending deliveries. More specifically, the recipient requests a Pick-up web page that shows the pending deliveries at event 90. The server returns the Pick-up page for display by the web browser to the recipient in accordance with events 92 and 94. To the extent that more than one data file is awaiting delivery, the recipient can pick which data files are to be downloaded to their computing device. An exemplary Pick-up page is shown in FIG. 6.

To download a data file, the recipient selects one or more of the pending deliveries displayed on the web page at event 96. The web browser posts the request to the server at event 98. The server application in turn marks the data file as pending download and returns a confirmation message for display on the Pick-up page to the recipient in accordance with events 100 and 102. The Pick-up page also includes a HTML scripting command that causes the web browser to initiate execution of the transfer agent as shown at event 104.

The transfer agent retrieves the pending deliveries from the server. Again, the transfer agent establishes a second network connection to the server that is independent of the web browser connection. The transfer agent asks the application server for any tasks that are to be performed at event 106. The server application in turn downloads the requested data files to the transfer agent at event 108. Once all of the data files have been successfully downloaded, the server application marks the files as downloaded and deletes them from the server as shown at events 110 and 112. When the server application replies that no more tasks remain, the polling process is complete as shown at events 114 and 116.

While the invention has been described in its presently preferred form, it will be understood that the invention is capable of modification without departing from the spirit of the invention as set forth in the appended claims.

What is claimed is:

1. A method for transferring data files between a first computing device and a second computing device interconnected by a network, comprising:
establishing a first network connection between the first computing device and a server;
registering a file transfer request for a data file with a server application residing on the server, the data file residing on the first computing device;
establishing a second network connection between the first computing device and the server, such that the second network connection is independent from the first network connection;
retrieving the file transfer request via the second network connection from the server application; and
transferring the data file from the first computing device via the second network connection to the server in response to the file transfer request retrieved from the server application.

2. The method of claim 1 wherein the steps of establishing a first network connection and a second network connection further comprise using a hypertext transfer protocol (HTTP).

3. The method of claim 1 wherein the steps of establishing a first network connection and a second network connection further comprise using a secure hypertext transfer protocol (HTTPS).

4. The method of claim 1 wherein the step of registering a file transfer further comprises specifying a first identifier for the data file and a second identifier for the intended recipient of the data file.

5. The method of claim 1 wherein the step of registering a file transfer further comprises storing the file transfer request in a memory space on the server and accessible to the server application

6. The method of claim 1 further comprises:
establishing a network connection between the second computing device and the server;
retrieving the file transfer request from the server application via the network connection between the second computing device and the server; and
transferring the data file to the second computing device in response to the file transfer request retrieved from the server application, the data file transferred via the network connection between the second computing device and the server.

7. The method of claim 6 wherein the step of establishing a network connection between the second computing device and the server further comprises using HTTP.

8. The method of claim 6 wherein the steps of transferring the data file further comprise using a Secure Sockets Layer (SSL) protocol.

9. The method of claim 6 further comprises notifying a user of the second computing device of the pending file transfer request.

10. The method of claim 9 further comprises sending an out-of-band message to the user of the second computing device.

11. The method of claim 9 further comprises:
establishing a second network connection between the second computing device and the server;
retrieving a pending file transfer indicator via the second network connection from the server application; and
displaying the pending file transfer indicator to the user of the second computing device.

12. An electronic file delivery system for transferring data files between a first computing device and a second computing device interconnected by a network, comprising:
a server application for coordinating a transfer of data files;
a requesting application residing on the first computing device, the requesting application operable to establish a network connection to the second computing device using a hypertext transfer protocol and to register a file transfer request for a data file with the server application; and
a transfer application residing on the first computing device and operable to establish a second network connection to the second computing device using the hypertext transfer protocol,
the transfer application further operable to retrieve the file transfer request from the server application and to transfer the data file to the second computing device in response to the file transfer request retrieved from the server application.

13. The electronic file delivery system of claim 12 wherein the file transfer request includes a first identifier for the data file and a second identifier for the intended recipient of the data file.

14. The electronic file delivery system of claim 12 further comprising a memory space residing on the second computing device, the memory space accessible to the server application for storing file transfer requests.

15. The electronic file delivery system of claim 12 wherein the requesting application is further defined as a web browser and the server application is further defined as a web server.

16. The electronic file delivery system of claim 12 wherein the server application resides on at least one of the second computing device or a third computing device.

17. The electronic file delivery system of claim 12 wherein the data files are transferred to the second computing device using a Secure Sockets Layer (SSL) protocol.

18. The electronic file delivery system of claim 12 further comprising a third computing device interconnected via the network to at least the second computing device, the third computing device having a transfer application operable to establish a network connection to the second computing device using the hypertext transfer protocol, the transfer application further operable to retrieve the file transfer request from the server application and to transfer the data file to the third computing device in response to the file transfer request retrieved from the server application.

19. An electronic file delivery system for transferring data files between a first computing device and a second computing device interconnected by a network, comprising:
a server application for coordinating a transfer of data files, the server application residing on the second computing device;
a requesting application residing on a third computing device, the requesting application operable to establish a network connection to the second computing device using a hypertext transfer protocol and to register a file transfer request for a data file with the server application; and
a transfer application residing on the first computing device and operable to establish a second network connection to the second computing device using the hypertext transfer protocol,
the transfer application further operable to retrieve the file transfer request from the server application and to transfer the data file to the second computing device in response to the file transfer request retrieved from the server application.
